(19) United States
(12) Patent Application Publication
(10) Pub. No.: US 2016/0277159 A1
(43) Pub. Date: Sep. 22, 2016

(54) DIVERSITY FILTERING

(71) Applicant: Microsoft Technology Licensing, LLC, Redmond, WA (US)

(72) Inventor: Andrew James Hillenius, Redmond, WA (US)

(21) Appl. No.: 14/881,676

(22) Filed: Oct. 13, 2015

Related U.S. Application Data
(60) Provisional application No. 62/135,033, filed on Mar. 18, 2015.

(51) Int. Cl. H04L 5/00; H04B 1/10

(52) U.S. Cl. CPC H04L 5/006; H04B 1/1027

(57) ABSTRACT

Example diversity systems are described. An example diversity receiver includes a first receiver coupled to a first antenna, the first receiver having a first front end including a filter, a second receiver having a second front end without a filter, the second receiver being coupled to a second antenna without a filter between the second receiver and the second antenna, and a combiner coupled to the first receiver and the second receiver and configured to receive data from the first receiver and the second receiver.

### CROSS REFERENCE TO RELATED APPLICATIONS

This application claims priority to U.S. Provisional Application No. 62/135,033, entitled “Asymmetric Diversity Filtering”, filed Mar. 18, 2015, the entirety of which is hereby incorporated herein by reference.

### BACKGROUND

Devices may feature wireless communication capabilities enabling signals to be transmitted over radiofrequency bands. Some environments, such as houses, workplaces, city centers, and other locations may include multiple devices with wireless communication capabilities. In some instances, the wireless devices in a given environment may communicate on similar frequency bands.

### BRIEF DESCRIPTION OF THE DRAWINGS

FIG. 1 shows an example environment including multiple wireless devices.

FIG. 2 shows an example communication system including a computing device with a diversity receiver.

FIGS. 3A and 3B show block diagrams of example diversity receivers.

FIG. 4 is a flow chart of an example method for operating a diversity receiver.

FIG. 5 shows block diagrams of example maximal-ratio combining (MRC) routines and modules.

FIG. 6 is a block diagram of an example computing device.

### DETAILED DESCRIPTION

Radio receivers may contend with strong interfering signals near the signal being received. Addressing interfering signal rejection may involve tradeoffs between interferer attenuation, desired signal attenuation, and cost. The present description provides a solution, which may be carried out at comparably low cost, allowing for radio implementations with diversity-configured receivers that dynamically balance tradeoffs in these key areas.

Some existing attempts at balancing these tradeoffs make use of multiple filters and hardware to switch filters in and out of the signal path. The efficacy of this approach may be limited by the inherent expense and degradation associated with switching RF signals. Switching components may produce insertion loss, which affects the desired signal, as well as finite isolation, which may further affect a filter's stop band attenuation.

The present disclosure contemplates a single filtered receiver frontend that provides protection for an entire diversity receiver system from the consequences of strong interferer signals. The single filter may provide a level of rejection of the interferer signals that mitigates such performance degradation and/or link loss. An example filter configuration may allow the receiver to balance two important areas of performance: blocker rejection and front end loss. Single receiver systems or diversity systems without asymmetric filtering cannot flexibly recover filtering loss when no blocking signal is present or switch band-pass filters into their frontend to protect against the sudden appearance of a strong blocker signal. The reduction in filter and switching elements, relative to some other approaches to address blocker rejection, allows for a much lower cost implementation than conventional systems in a noise-limited coexistence environment. The disclosed filter configuration further allows a diversity receiver with multiple spatially diverse antennas to achieve superior reception in a fading environment than a conventional system without diversity.

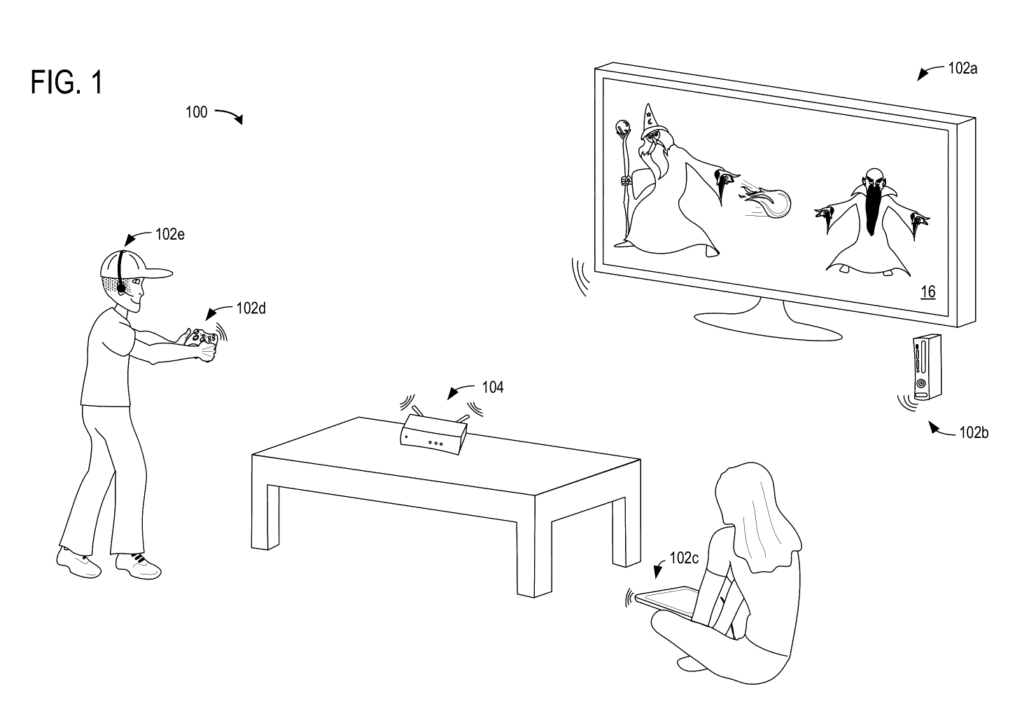

FIG. 1 shows an example environment 100 in which a plurality of wireless devices 102a, 102b, 102c, and 102d may interact with one another and/or with a wireless router 104 in order to connect to a network. For example, wireless device 102a may include a smart television; wireless device 102b may include a video gaming or other home entertainment system; wireless device 102c may include a tablet or other mobile computing device; wireless device 102d may include a game controller; and wireless device 102e may include a wireless headset. Each wireless device includes wireless connectivity capability. The illustrated wireless devices are exemplary and any suitable wireless device may utilize a diversity receiver as described herein.

In the illustrated example, the wireless devices may communicate via one or more wireless communication protocols and/or on one or more radio frequency bands. For example, game controller 102d and wireless headset 102e may communicate with video gaming system 102b via BLUETOOTH, while smart television 102a, video gaming system 102b, and tablet 102c may communicate with the wireless router 104 via WIFI. Accordingly, such an environment may be saturated to a high degree with wireless signaling.

A wireless device may be configured to receive signals on a selected frequency band (e.g., channel). However, transmissions may be present on other nearby frequency bands/channels that interfere with the signal intended to be received. Such interfering signals may be referred to as blocking or blocker signals. In order to attenuate such signals, a filter may be positioned in a front end of a receiver (e.g., between the receiver and an associated antenna). The filter may be a band-pass or similar filter configured to pass signals within the selected frequency band and attenuate (e.g., discard/filter out) signals on other frequency bands. In other examples, the filter may be a low pass, high pass, notch, tunable filter, and/or multiple filters with different center frequencies. However, each element positioned between an antenna and a receiver (e.g., each element through which an incoming signal passes, including but not limited to filters, sensors, and/or other intermediary elements) may contribute to insertion loss (and thus total front-end loss) that affects the incoming signal (e.g., lowers the loss, attenuation, and/or signal power of the incoming signal and/or otherwise degrades the incoming signal). Accordingly, the present disclosure contemplates a diversity receiving system that at least reduces front-end losses by removing elements other than those that directly reduce the presence of blocker signals. For example, the diversity system may minimize front-end losses by the removal of elements described above.

Although multiple transmitting/receiving devices may be present in a given environment, each device may not continually transmit/receive signals on an associated frequency band. Accordingly, the continued use of filters in receiver front ends may lead to the presence of unnecessary loss of signal power due to the insertion loss of the filter(s). A sensor may be placed between an antenna and a receiver in order to detect whether interfering signals are present, however such a sensor may result in further insertion/front-end loss, and add processing delays and complexity to the system.

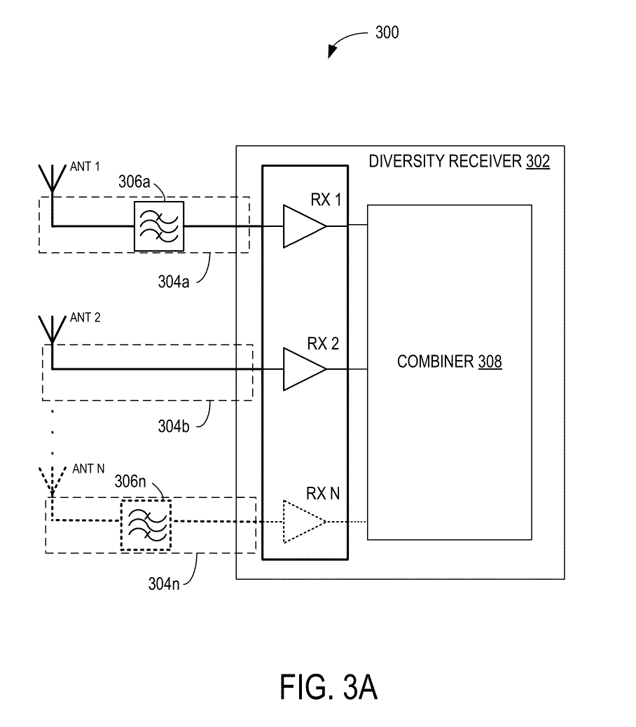

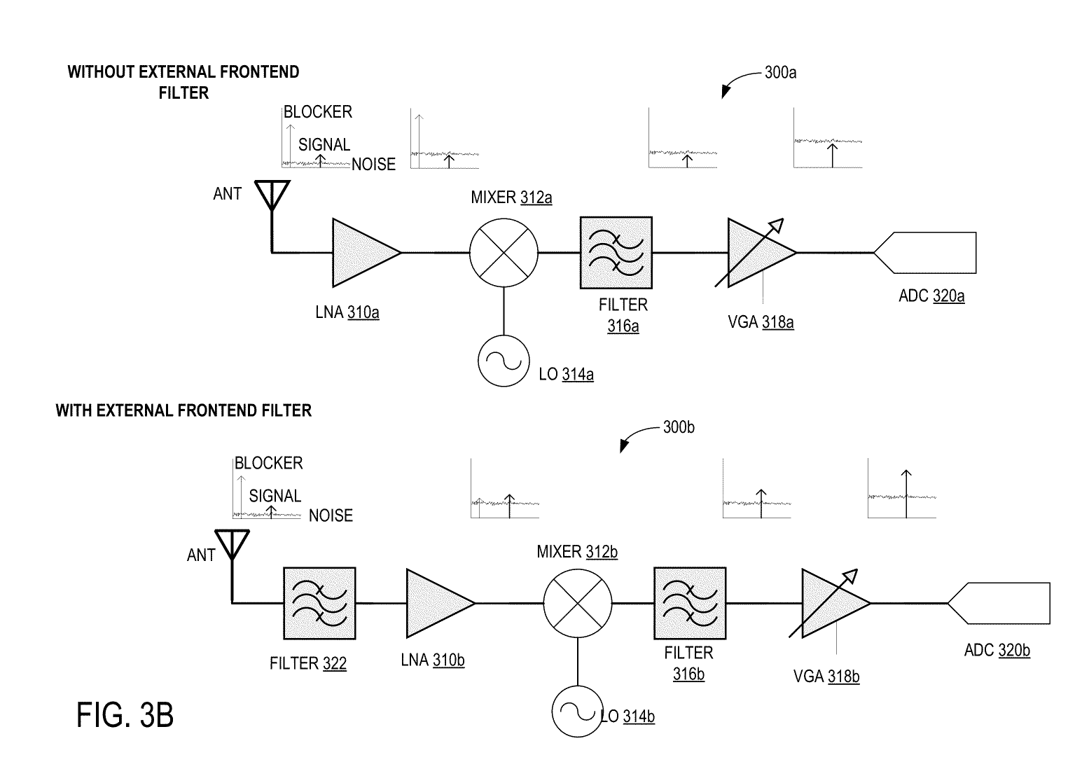

In order to reduce insertion loss to incoming, to be decoded signals while maintaining cost-efficient implementations, the present disclosure provides a diversity receiver including multiple receivers with asymmetric front ends. In these examples, incoming signals may traverse multiple paths, at least one of which includes a filter (e.g., between a first antenna and a first receiver), and at least one of which does not include a filter (e.g., between a second antenna and a second receiver). A combiner that receives the signals from the different paths may employ a combining technique (e.g., a maximal-ratio combining (MRC) routine, a selection combining routine, an equal gain combining routine, and/or another suitable combining technique) to apply gains to signals from each path or select signals from each path, in order to selectively decode signals downstream from a module executing the combining technique based on the assessed SNR in order to generate a combined signal. The combined signal may take advantage of the higher signal-to-noise ratio (SNR) signal of the non-filtered path when interfering signals are not present, and the less noisy signal of the filtered path when interfering signals are present. The use of the MRC routine enables the diversity receiver system to identify opportunities to use high SNR signals (e.g., when interfering signals are not present) from filterless paths, without relying on an external sensor in one or more receiver front-ends. The construction of the diversity receiver is described in more detail below with respect to FIG. 3.

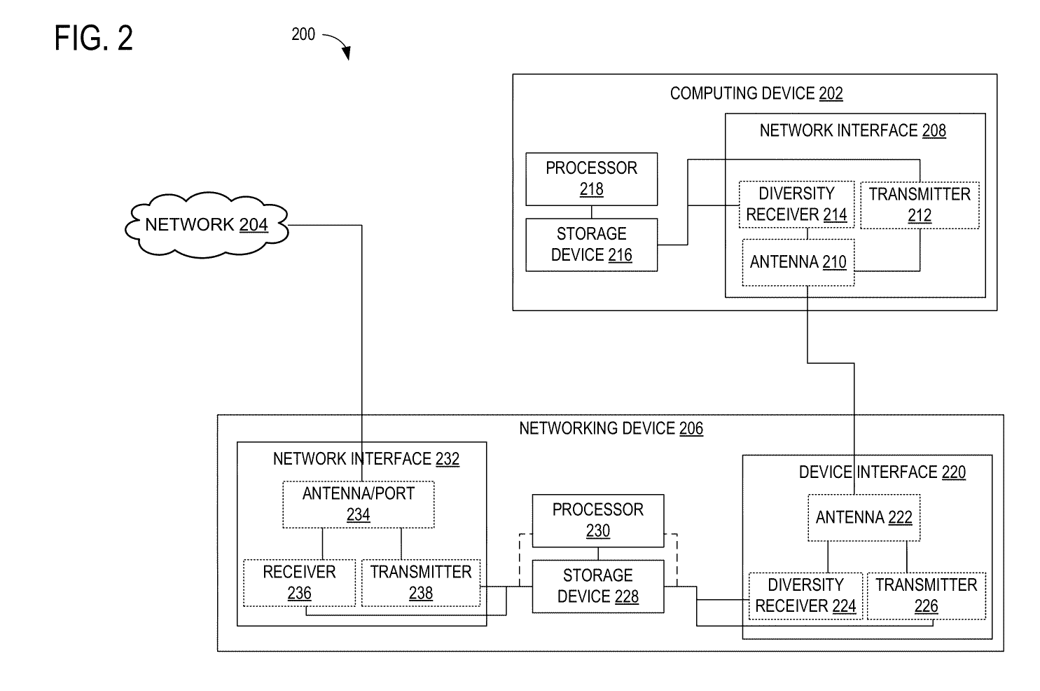

FIG. 2 shows an example communication system 200 in which a computing device 202 may communicate with a network 204 via a networking device 206. For example, computing device 202 may be an example of one or more of the wireless devices 102a-e of FIG. 1 and networking device 206 may be an example of the wireless router 104 of FIG. 1. Computing device 202 may include a network interface 208 for communicating with other devices (e.g., networking device 206). The network interface 208 may be configured for any suitable wireless network and/or communications protocol, including but not limited to WIFI, WIFI Direct, BLUETOOTH, NFC, and/or other wireless communication mechanisms. In some examples, the computing device may include a plurality of network interfaces for communicating via different communication mechanisms and/or for redundantly communicating via the same communication mechanism. In some such examples, one or more elements of the plurality of network interfaces (e.g., an antenna 210) may be shared amongst some or all of the network interfaces.

The network interface 208 may include the antenna 210 for transmitting and receiving data, a transmitter 212 for providing outgoing data to the antenna 210, and a diversity receiver 214 for receiving and/or processing incoming data from the antenna 210. A storage device 216 may provide outgoing data to the transmitter 212 and/or store incoming data from the diversity receiver 214. The computing device 202 may also include a processor 218 for executing instructions (e.g., stored on storage device 216) and/or processing incoming and/or outgoing data.

The computing device 202 may exchange data with the networking device 206 via a device interface 220 of the networking device 206. The device interface 220 may include similar elements as the network interface 208 of the computing device 202. For example, data may be transmitted to and/or received from the computing device 202 via antenna 222, and passed to/from diversity receiver 224 and transmitter 226, respectively. The networking device 206 may include a storage device 228 and a processor 230 for performing similar tasks as described above for storage device 216 and processor 218 of computing device 202. In some examples, processor 230 may be configured to format data for transmission to the network 204. For example, incoming data from the computing device may be formatted in a first format, but the network 204 may recognize data formatted in a different, second format. Accordingly, processor 230 may parse, decode, encode, packetize/encapsulate, and/or otherwise modify the data received via the device interface 220 for communication to the network 204.

Networking device 206 may communicate with the network 204 via a network interface 232. Network interface 232 may include an antenna and/or a port 234. For example, if networking device 206 is connected to a cellular network, the networking device may communicate data to/from the network via an antenna. If the networking device is connected to an internet service provider, a local area network (LAN)/wireless local area network (WLAN), and/or another suitable network, the networking device may communicate data to/from the network via a port (e.g., an Ethernet port, a coaxial port, and/or another suitable port). Received/transmitted data may be provided to/from receiver 236 and transmitter 238, respectively, and further to/from storage device 228 and/or processor 230.

FIG. 3A shows a detailed view of a diversity receiver system 300 including a diversity receiver 302. Diversity receiver 302 may be an example of diversity receiver 214 and/or diversity receiver 224 of FIG. 2. As illustrated, diversity receiver 302 includes a plurality of receivers RX 1 and RX 2, each connected to a respective antenna (ANT 1 and ANT 2). The illustrated example shows each receiver separately connected to a different antenna, such that each of the antennas are spatially separated and/or are directed differently. Such a configuration may provide a further reduction in interfering signal reception and/or achieve a higher overall signal-to-noise ratio (SNR) for incoming signals, as each antenna may provide for a different coverage area. However, in other examples, each or some of the plurality of receivers in the diversity receiver may be connected to the same antenna in order to reduce cost, complexity, size, weight, and/or other parameters of the receiver.

Each of RX 1 and RX 2 may have an associated front end 304a and 304b, respectively. The front end of the receiver may correspond to the region between the receiver and the associated antenna to which that receiver is connected. Accordingly, in some examples, the front end is external to a chip in which the diversity receiver is implemented. For example, the front end may encompass the entire path from the antenna to the receiver. RX 1 and RX 2 may have asymmetric front ends, as the front end 304a of RX 1 includes a filter 306a and the front end 304b of RX 2 does not include a filter (e.g., no filters being present between RX 2 and associated ANT 2). A signal received via a first path from ANT 1 to RX 1 may have a lower power or SNR than a signal received via a second path from ANT 2 to RX 2 due to the insertion loss of the filter 306a. As illustrated, RX 2 is connected to ANT 2 without any intervening filters (e.g., directly), such that the second path does not have any filters and the signal is received at RX 2 from ANT 2 without passing through any filters. Such a filterless connection between RX 2 and ANT 2 causes the signal received at RX 2 to have approximately the same power as the signal received at ANT 2. In contrast, a signal received at RX 1 may have an approximately 4 dB loss in power from the signal received at ANT 1, in one example. However, when blocker signals are present, filter 306a may be configured to filter out the blocker signals. For example, filter 306a may be a band-pass filter (e.g., a dielectric or surface acoustic wave [SAW] filter configured to only allow signals in a selected frequency range, such as a channel from which data is being received, to pass). In this way, filter 306a may increase the SNR of signals received via the first path relative to the SNR of signals received via the second path when such blocker signals are present.

As illustrated, one or more additional receivers (represented by RX N) and associated front ends (represented by 304n) and antennas (represented by ANT N) may be included in and/or coupled to the diversity receiver 302. One or more of these additional receivers may include front ends with a filter (represented by 306n) or without a filter. A diversity receiver with more than two receivers may utilize multiple filters to provide a finer grain tradeoff between blocker rejection and signal attenuation.

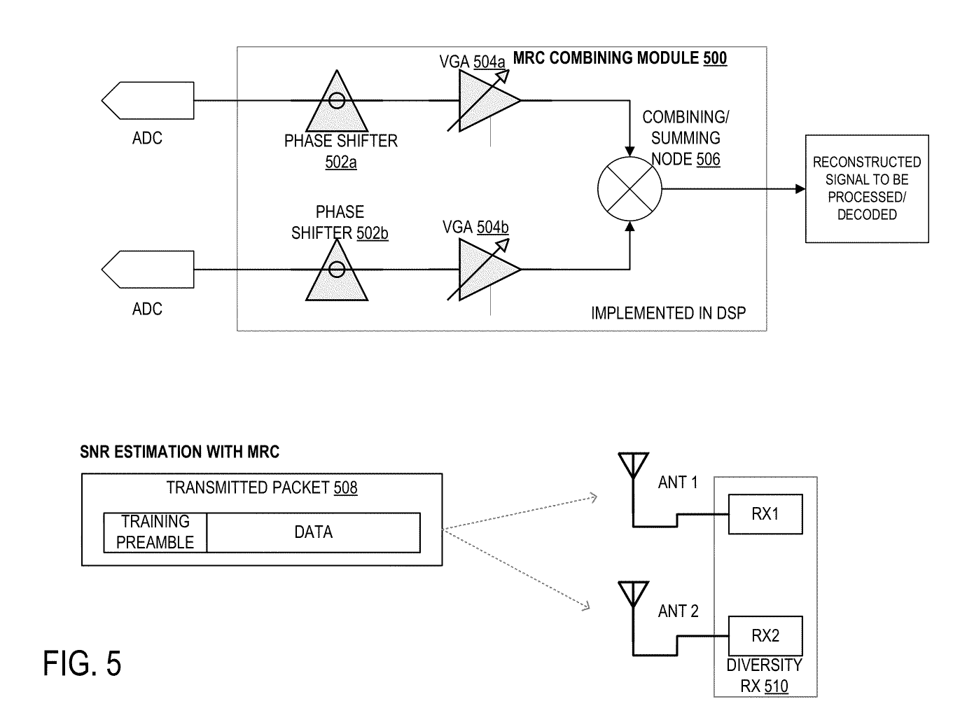

Signals from each receiver (e.g., RX 1, RX 2, and one or more optional additional receivers represented by RX N) are received at combiner 308. The combiner 308 may evaluate parameters of the signals from each receiver, selectively process the received signals (e.g., according to an MRC routine), and generate a combined signal. The combined signal may be configured to have a maximum gain and SNR for a given condition of the communication environment (e.g., based on the presence or absence of interfering signals), and may be provided to a storage device and/or processor of a computing device in which the diversity receiver is located/integrated (e.g., as described above with respect to FIG. 2). The combiner 308 may measure the SNR for each of the signals received from the receivers in some examples. In additional or alternative examples, the combiner 308 may determine the SNR for each of the signals based on an inspection of the preamble or other data in the signals. For example, the signals from the connected receivers may be packetized data (e.g., WIFI packets), and the combiner 308 may evaluate the headers and/or payload of the received packets to determine the SNR of the associated signal. Based on the measured/determined SNR of each of the signals received at the combiner 308, the combiner may selectively change a weighting applied to each signal for generating a combined signal. An example combining process and module are described in more detail below with respect to FIG. 5.

For example, a combined signal (e.g., for decoding) may be generated based only on (e.g., including only data from) a signal from a receiver that does not include a filter in the associated front end (e.g., RX 2) when the SNR of the signal is above a threshold (e.g., indicating that no interfering signals are present). In another example, the combined signal may be generated based only on (e.g., including only data from) a signal from a receiver that includes a filter in the associated front end (e.g., RX 1) when the SNR of the received signals indicates that heavy interfering signals are present (e.g., when the SNR of the signal from RX 2 is below a threshold). In still another example, the combined signal may be split between signals received from some or all of the receivers, such that at least a portion of some or all of the receivers is used to generate the combined signal.

In an example execution of an MRC routine, the combiner 308 may add the signals from each receiver together, adjust the gain of each signal to be proportional to the root mean square (rms) signal level and inversely proportional to the mean square noise level in that channel, and different proportionality constants may be used for each channel (e.g., each signal from the receivers). In this way, the combiner 308 may achieve a balance of signal gain and SNR for the combined signal by utilizing portions of signals received from each of the receivers. The signals are combined to increase desired signal power while avoiding increasing signal noise. The combiner 308 may then output the combined signal to another module of the computing device in which the diversity receiver system 300 is housed (e.g., to a storage device and/or processor of the computing device, for decoding in one example).

FIG. 3B shows a detailed block diagram of example receivers and associated front ends for a diversity receiver (e.g., diversity receiver system 300 of FIG. 3A). For example, receiver and associated frontend 300a may be used in diversity receiver system 300 as the components of RX1, frontend 304a, and ANT1 of FIG. 3A. As illustrated, receiver and associated frontend 300a includes an antenna, which receives and passes a signal onto a low-noise amplifier (LNA) 310a. The signal is then passed to mixer 312a and local oscillator (LO) 314a to change the frequency of the signal and then to a filter 316a. A variable-gain amplifier (VGA) 318a is used to further amplify the signal, which is then passed to an analog-to-digital converter (ADC) 320a. The LNA, mixer, LO, filter, VGA, and ADC may be components of the receiver, as the receiver and associated frontend 300a does not include a filter. The effect of the components on the blocker signal noise is illustrated via the associated graphs above the block diagram. Without external filtering, the blocking signal can significantly exceed the power of the desired signal (as illustrated in the graph above the antenna). This undesired high power signal is shown causing gain compression in the first stage amplifiers (310a) such that the desired signal is now attenuated below the noise floor. After the signal is down converted to IF frequencies, because the signal to noise ratio has been degraded by the blocking in the first stage, the IF filtering and VGA are unable to recover the desired signal (the last two graphs above the block diagram for receiver and associated frontend 300a), With external filtering, the blocking signal is attenuated before it reaches the first stage amplifiers, such that the desired signal is amplified above the noise floor (second graph). After down conversion, the IF filtering is able to remove the blocker entirely (third graph) and the VGA can amplify the signal for sampling by the ADC (fourth graph).

Receiver and associated frontend 300b may be used in diversity receiver system 300 of FIG. 3A as the components of RX2, frontend 304b, and ANT2. Receiver and associated frontend 300b includes the same components as receiver and associated frontend 300a (e.g., LNA 310b, Mixer 312b, LO 314b, filter 316b, VGA 318b, and ADC 320b), but also includes an additional filter 322 in the frontend of the receiver (e.g., between the antenna and LNA 310b). Once again, the effect of the components on the blocker signal noise is illustrated via the associated graphs above the block diagram as described above.

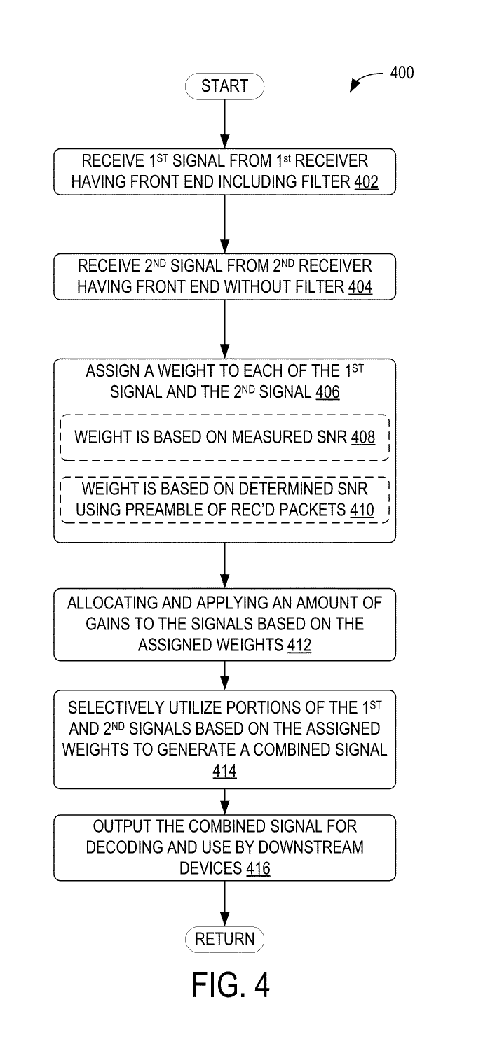

FIG. 4 shows an example method 400 for operating a diversity receiver. For example, method 400 may be performed by diversity receiver system 300 of FIG. 3. At 402, the method includes receiving a first signal from a first receiver having a front end including a filter. At 404, the method includes receiving a second signal from a second receiver having a front end without a filter. At 406, the method includes assigning a weight to each of the first signal and the second signal. As indicated at 408, the weight may be based on a measured SNR. Additionally, or alternatively, the weight may be based on a determined SNR that is identified by analyzing a preamble of received packets, as indicated at 410.

At 412, the method includes allocating and applying an amount of gains to each signal based on the assigned weights. At 414, the method includes selectively utilizing portions of the first and the second signals as adjusted by the allocated and applied gains based on the assigned weights to generate a combined signal. At 416, the method includes outputting the combined signal for decoding and use by downstream devices. For example, the combined signal may primarily include data from the first signal or the second signal, as a greater amount of gain may be applied to the first signal or the second signal when generating the combined signal. In some examples, one of the signals may be completely attenuated such that the data from that signal is not included in the combined signal. In this way, a combiner may generate a combined signal having a combining ratio of the first signal to the second signal that is based on SNR.

FIG. 5 shows an example block diagram of an MRC combining circuitry (e.g., which may be a module or combination of modules in a processor, dedicated circuitry such as an Application-Specific Integrated Circuit [ASIC], and/or other circuitry) and illustrates an example routine for SNR estimation with the MRC combining circuitry. As illustrated, signals received from the ADC of each receiver in a diversity receiver system may be sent to the MRC combining circuitry 500. The MRC combining circuitry 500 may include and/or be included in a combiner of a diversity receiver system, such as combiner 308 of FIG. 3A. The MRC combining circuitry 500 may be implemented in a digital signal processor (DSP) in some examples. As illustrated, incoming signals are passed to a phase shifter 502a/502b for matching the phases of the signals. The signals are then passed to a VGA 504a/504b to selectively adjust a gain of the signal based on the signal's SNR. The adjusted signals are then passed to a combining/summing node 506 and output as a reconstructed signal to be processed and/or decoded downstream.

The SNR estimation used to operate the VGA 504a/b is also illustrated in FIG. 5. A transmitted packet 508 may be received at the antenna of each receiver in a diversity receiver 510. The transmitted packet 508 may include a training preamble and data (payload). As described above, the training preamble may include an indication of SNR for that packet, which may then be used by the MRC combining circuitry (e.g., as the ADCs may be included in the diversity receiver 510, the transmitted packet 508 may be received at the MRC combining circuitry 500 via the respective ADCs) to assign scaling factors for applying gain/attenuation to each of the signals. Using the SNR estimates from the packet training field (the training preamble), the baseband (e.g., a chipset's baseband, which may include the DSP used to implement the MRC combining circuitry) may assess whether the samples from all receivers will contribute to decoding the signal and not allocate system resources to processing those samples. Once the raw data from the receivers is converted by the analog to digital converters all the decoding and MRC functions may be done with signal processing code. Using the SNR estimates from the packet training field, the baseband can assess whether the samples from all receivers will contribute to decoding the signal and not allocate system resources to processing those samples.

In operation, the MRC combining circuitry may continuously compare sampled data from the ADC against the known data in a packet preamble, (e.g., a training field). Because the expected data inside the training field is known by the receiver the sampled receiver data can be auto-correlated to both trigger a detection and estimate the quality of the received preamble which is directly related to the signal's SNR. This estimate based on the preamble is used until the end of the packet or the next packet preamble is detected. After the preamble is complete the weighting can be adjusted or tracked as data is decoded from the packet.

The above-described diversity receiver enables the associated communication system to balance two key areas of performance: blocker rejection and frontend loss. Single receiver systems or diversity systems with no asymmetric filtering cannot flexibly recover filtering loss when no blocking signal is preset or switch band-pass filters into their frontend to protect against the sudden appearance of a strong blocker signal (e.g., between two closely spaced WIFI packets). The reduction in filter and switch elements results in accomplishing a much lower cost implementation than conventional systems in a noise limited coexistence environment while allowing a diversity receiver with multiple spatially diverse antennas to achieve superior reception in a fading environment than a conventional system without diversity.

In some embodiments, the methods and processes described herein may be tied to a computing system of one or more computing devices. In particular, such methods and processes may be implemented as a computer-application program or service, an application-programming interface (API), a library, and/or other computer-program product.

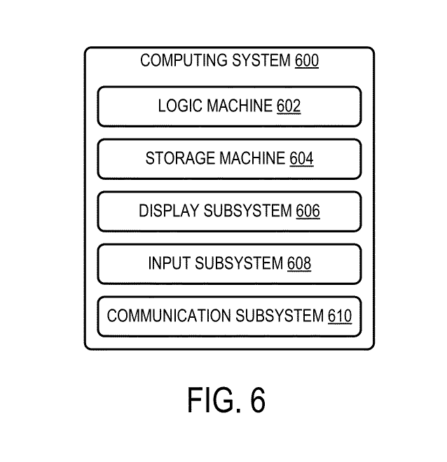

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices. For example, computing system 600 may be an example of wireless devices 102a-e of FIG. 1, computing device 202 and/or networking device 206 of FIG. 2, and/or a computing device including the diversity receiver system 300 of FIG. 3. Computing system 600 may be an example of a computing system including a diversity receiver to perform method 400 of FIG. 4.

Computing system 600 includes a logic machine 602 and a storage machine 604. Computing system 600 may optionally include a display subsystem 606, input subsystem 608, communication subsystem 610, and/or other components not shown in FIG. 6.

Logic machine 602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 604 includes one or more physical devices configured to hold instructions executable by the logic machine to implement the methods and processes described herein. When such methods and processes are implemented, the state of storage machine 604 may be transformed—e.g., to hold different data.

Storage machine 604 may include removable and/or built-in devices. Storage machine 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 604 may include volatile, nonvolatile, dynamic, static, read/write, read-only, random-access, sequential-access, location-addressable, file-addressable, and/or content-addressable devices.

It will be appreciated that storage machine 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage machine 604. This visual representation may take the form of a graphical user interface (GUI). As the herein described methods and processes change the data held by the storage machine, and thus transform the state of the storage machine, the state of display subsystem 606 may likewise be transformed to visually represent changes in the underlying data. Display subsystem 606 may include one or more display devices utilizing virtually any type of technology. Such display devices may be combined with logic machine 602 and/or storage machine 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet. For example, the communication subsystem 610 may include the diversity receiver system 300 of FIG. 3.

An example diversity receiver includes a first receiver coupled to a first antenna, the first receiver having a first front end including a filter, a second receiver having a second front end without a filter, the second receiver being coupled to a second antenna without a filter between the second receiver and the second antenna, and a combiner coupled to the first receiver and the second receiver and configured to receive data from the first receiver and the second receiver. Such an example additionally or alternatively includes the diversity receiver further comprising a third receiver having a third front end without a filter, the third receiver being coupled to a third antenna without a filter between the third receiver and the third antenna, and the combiner further coupled to the third receiver and configured to receive data from the third receiver. Such an example additionally or alternatively includes the diversity receiver further comprising a third receiver having a third front end including a filter, the combiner further coupled to the third receiver and configured to receive data from the third receiver. Such an example additionally or alternatively includes the diversity receiver, wherein the first antenna is different from the second antenna. Such an example additionally or alternatively includes the diversity receiver, wherein the combiner operates according to maximal-ratio combining (MRC). Such an example additionally or alternatively includes the diversity receiver, wherein the combiner is configured to allocate gains for received signals on each of a first path from the first receiver and a second path from the second receiver based at least on the MRC. Such an example additionally or alternatively includes the diversity receiver, wherein the combiner is configured to measure a signal-to-noise ratio (SNR) on each of the first path and the second path and allocate the gains based at least on the measured SNR. Such an example additionally or alternatively includes the diversity receiver, wherein the combiner is configured to determine a signal-to-noise ratio (SNR) on each of the first path and the second path based at least on one or more preambles of incoming packets on each path, and allocate the gains based at least on the determined SNR. Such an example additionally or alternatively includes the diversity receiver, wherein the filter included in the front end of the first receiver comprises one or more filters configured to filter out a blocker signal. Any or all of the above-described examples may be combined in any suitable manner in various implementations.

An example method for selectively decoding incoming signals at a diversity receiver includes receiving, at a combiner of the diversity receiver, a first signal from a first receiver of the diversity receiver coupled to a first antenna, the first receiver having a front end including a filter, receiving, at the combiner of the diversity receiver, a second signal from a second receiver of the diversity receiver coupled to a second antenna without a filter positioned between the second receiver and the second antenna, the second receiver having a front end without a filter, assigning, with the combiner, a weight to each of the first signal and the second signal based at least on a signal-to-noise ratio (SNR) of each of the first signal and the second signal, and allocating an amount gains to each of the first signal and the second signal based at least on the weight for each of the first signal and the second signal. Such an example additionally or alternatively includes the method, further comprising outputting a combined signal comprising decoded data selectively decoded from the first signal and the second signal according to the allocated amount of gains. Such an example additionally or alternatively includes the method, further comprising receiving, at the combiner, a third signal from a third receiver of the diversity receiver coupled to a third antenna without a filter positioned between the third receiver and the third antenna, the third receiver having a front end not including a filter, and the combined signal comprising decoded data selectively decoded from the first signal, the second signal, and the third signal according to an allocated amount of gains that are allocated according to maximal ratio combining (MRC). Such an example additionally or alternatively includes the method, further comprising receiving, at the combiner, a third signal from a third receiver of the diversity receiver coupled to a third antenna, the third receiver having a front end including a filter, and the combined signal comprising decoded data selectively decoded from the first signal, the second signal, and the third signal according to an allocated amount of gains that are allocated according to maximal ratio combining (MRC). Such an example additionally or alternatively includes the method, wherein assigning, with the combiner, the weight to each of the first signal and the second signal comprises measuring, with the combiner, the SNR of each of the first signal and the second signal. Such an example additionally or alternatively includes the method, wherein assigning, with the combiner, the weight to each of the first signal and the second signal comprises determining, with the combiner, the SNR of each of the first signal and the second signal based at least on a preamble of incoming packets received from each of the first receiver and the second receiver. Any or all of the above-described examples may be combined in any suitable manner in various implementations.

Another example diversity receiver includes a first receiver coupled to a first antenna, the first receiver having a first front end including a filter, a second receiver having a second front end without a filter, the second receiver being coupled to a second antenna without a filter between the second receiver and the second antenna, and a combiner coupled to the first receiver and the second receiver and configured to receive data from the first receiver and the second receiver, select a portion of one of more of the first signal and the second signal based at least on a signal-to-noise ratio (SNR) of each of the first signal and the second signal to selectively decode portions of the first signal and the second signal, and output a combined signal comprising the decoded portions of one or more of the first signal and the second signal. Such an example additionally or alternatively includes the diversity receiver, further comprising a third receiver having a third front end without a filter, the third receiver being coupled to a third antenna without a filter between the third receiver and the third antenna, and the combiner further coupled to the third receiver and configured to receive and selectively decode data from the third receiver to generate the combined signal. Such an example additionally or alternatively includes the diversity receiver, further comprising a third receiver having a third front end including a filter, the combiner further coupled to the third receiver and configured to receive and selectively decode data from the third receiver to generate the combined signal. Such an example additionally or alternatively includes the diversity receiver, wherein selecting a portion of one or more of the first signal and the second signal based at least on a signal-to-noise ratio (SNR) of each of the first signal and the second signal comprises measuring the signal-to-noise ratio (SNR) on each of the first path and the second path and selectively using only the first signal, only the second signal, or portions of each of the first signal and the second signal to generate the combined signal. Such an example additionally or alternatively includes the diversity receiver, wherein selecting a portion of one or more of the first signal and the second signal based at least on a signal-to-noise ratio (SNR) of each of the first signal and the second signal comprises determining the signal-to-noise ratio (SNR) on each of the first path and the second path based at least on one or more preambles of incoming packets on each path. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A diversity receiver comprising:
a first receiver coupled to a first antenna, the first receiver having a first front end including a filter;
a second receiver having a second front end without a filter, the second receiver being coupled to a second antenna without a filter between the second receiver and the second antenna; and
a combiner coupled to the first receiver and the second receiver and configured to receive data from the first receiver and the second receiver.

2. The diversity receiver of claim 1, further comprising a third receiver having a third front end without a filter, the third receiver being coupled to a third antenna without a filter between the third receiver and the third antenna, and the combiner further coupled to the third receiver and configured to receive data from the third receiver.

3. The diversity receiver of claim 1, further comprising a third receiver having a third front end including a filter, the combiner further coupled to the third receiver and configured to receive data from the third receiver.

4. The diversity receiver of claim 1, wherein the first antenna is different from the second antenna.

5. The diversity receiver of claim 1, wherein the combiner operates according to maximal-ratio combining (MRC).

6. The diversity receiver of claim 5, wherein the combiner is configured to allocate gains for received signals on each of a first path from the first receiver and a second path from the second receiver based at least on the MRC.

7. The diversity receiver of claim 6, wherein the combiner is configured to measure a signal-to-noise ratio (SNR) on each of the first path and the second path and allocate the gains based at least on the measured SNR.

8. The diversity receiver of claim 6, wherein the combiner is configured to determine a signal-to-noise ratio (SNR) on each of the first path and the second path based at least on one or more preambles of incoming packets on each path, and allocate the gains based at least on the determined SNR.

9. The diversity receiver of claim 1, wherein the filter included in the front end of the first receiver comprises one or more filters configured to filter out a blocker signal.

10. A method for selectively decoding incoming signals at a diversity receiver, the method comprising:
receiving, at a combiner of the diversity receiver, a first signal from a first receiver of the diversity receiver coupled to a first antenna, the first receiver having a front end including a filter;
receiving, at the combiner of the diversity receiver, a second signal from a second receiver of the diversity receiver coupled to a second antenna without a filter positioned between the second receiver and the second antenna, the second receiver having a front end without a filter;
assigning, with the combiner, a weight to each of the first signal and the second signal based at least on a signal-to-noise ratio (SNR) of each of the first signal and the second signal; and
allocating an amount gains to each of the first signal and the second signal based at least on the weight for each of the first signal and the second signal.

11. The method of claim 10, further comprising outputting a combined signal comprising decoded data selectively decoded from the first signal and the second signal according to the allocated amount of gains.

12. The method of claim 11, further comprising receiving, at the combiner, a third signal from a third receiver of the diversity receiver coupled to a third antenna without a filter positioned between the third receiver and the third antenna, the third receiver having a front end not including a filter, and the combined signal comprising decoded data selectively decoded from the first signal, the second signal, and the third signal according to an allocated amount of gains that are allocated according to maximal ratio combining (MRC).

13. The method of claim 11, further comprising receiving, at the combiner, a third signal from a third receiver of the diversity receiver coupled to a third antenna, the third receiver having a front end including a filter, and the combined signal comprising decoded data selectively decoded from the first signal, the second signal, and the third signal according to an allocated amount of gains that are allocated according to maximal ratio combining (MRC).

14. The method of claim 11, wherein assigning, with the combiner, the weight to each of the first signal and the second signal comprises measuring, with the combiner, the SNR of each of the first signal and the second signal.

15. The method of claim 11, wherein assigning, with the combiner, the weight to each of the first signal and the second signal comprises determining, with the combiner, the SNR of each of the first signal and the second signal based at least on a preamble of incoming packets received from each of the first receiver and the second receiver.

16. A diversity receiver comprising:
a first receiver coupled to a first antenna, the first receiver having a first front end including a filter;
a second receiver having a second front end without a filter, the second receiver being coupled to a second antenna without a filter between the second receiver and the second antenna; and
a combiner coupled to the first receiver and the second receiver and configured to receive data from the first receiver and the second receiver,
select a portion of one of more of the first signal and the second signal based at least on a signal-to-noise ratio (SNR) of each of the first signal and the second signal to selectively decode portions of the first signal and the second signal, and
output a combined signal comprising the decoded portions of one or more of the first signal and the second signal.

17. The diversity receiver of claim 16, further comprising a third receiver having a third front end without a filter, the third receiver being coupled to a third antenna without a filter between the third receiver and the third antenna, and the combiner further coupled to the third receiver and configured to receive and selectively decode data from the third receiver to generate the combined signal.

18. The diversity receiver of claim 16, further comprising a third receiver having a third front end including a filter, the combiner further coupled to the third receiver and configured to receive and selectively decode data from the third receiver to generate the combined signal.

19. The diversity receiver of claim 16, wherein selecting a portion of one or more of the first signal and the second signal based at least on a signal-to-noise ratio (SNR) of each of the first signal and the second signal comprises measuring the signal-to-noise ratio (SNR) on each of the first path and the second path and selectively using only the first signal, only the second signal, or portions of each of the first signal and the second signal to generate the combined signal.

20. The diversity receiver of claim 16, wherein selecting a portion of one or more of the first signal and the second signal based at least on a signal-to-noise ratio (SNR) of each of the first signal and the second signal comprises determining the signal-to-noise ratio (SNR) on each of the first path and the second path based at least on one or more preambles of incoming packets on each path.
